(19) United States
(12) Patent Application Publication
(10) Pub. No.: US 2008/0121497 A1
(43) Pub. Date: May 29, 2008

(54) HEATED/COOL SCREW CONVEYOR

(76) Inventors: Christopher Esterson, Seaford, DE (US); Karl Walinskas, Ocean Pines, MD (US)

Correspondence Address: Connolly Bove Lodge & Hutz LLP, P.O. Box 2207, Wilmington, DE, 19899-2207, US

(21) Appl. No.: 11/563,354

(22) Filed: Nov. 27, 2006

(51) Int. Cl. B65G 33/00; B65G 33/24; F27D 3/08

(52) U.S. Cl. 198/657; 432/154; 432/239

(57) ABSTRACT

A screw conveyor includes a hollow rotatable shaft having an externally mounted flight extending along a portion of its length. Thermal applicating structure is provided at one end of the shaft for heating or cooling the screw conveyor. A thermosyphon is mounted within the shaft. The thermosyphon includes a hollow tube mounted against and in direct surface to surface contact with the shaft to rotate co-jointly with the shaft.

### BACKGROUND OF THE INVENTION

There are various applications of screw conveyors which are heated or cooled depending on the intended purpose. In one such application carbon black pellets are conveyed for use in rubber compounding. A preferred form of conveyance is a screw conveyor because the conveyor also acts as a feeder capable of delivering precise amounts of carbon black to a weigh hopper. Carbon black pellets are extremely small and fragile. The rubber mixing process is generally a batch operation requiring the movement of large volumes of carbon black in an intermittent fashion. As the carbon black is shuttled through the process some portion of the fragile pellets break down and become micron size particles of dust known as fines. Carbon black fines have an affinity for anything they come in contact with including themselves. Over time a build up of carbon black fines develops on the screw of the conveyor and eventually takes up so much volume that the screw must be removed for cleaning. Depending on the volume of carbon black moved through the screw this could be done several times per year at great expense due to labor and lost production. History has shown that by heating the screw to a temperature at or above 100° C., such as disclosed in U.S. Pat. No. 4,834,647, the carbon black loses its affinity for the surface of the screw and therefore no buildup of fines will occur. This results in a much more efficient and consistent process.

The current state of the art for heating the screw is to insert an electric cartridge heater inside the hollow screw pipe. The cartridge heater should be longer than the screw itself to facilitate mechanical attachment. If the screw conveyor is over 12 ft. long two heaters are required to be inserted from each end significantly increasing the overall length of the conveyor. The cartridge heater is stationary while the screw rotates around it. Heat is transferred to the screw from the heater mostly by radiation with the minimal amount of convection. This method is only about 40% efficient, meaning that to achieve a screw temperature of 100° C. requires a heater temperature of 250° C. The thermal profile of the heated screw is also not uniform. The hottest section is at the center of the screw with the ends of the screw being cooler. The uneven thermal profile can result in fines building up at the in-feed and discharge ends of the screw. Additionally, because the cartridge heater does not rotate with the screw the heater is subject to wear and vibration that shortens its useful life. The result is an expensive system both in initial cost and in the cost of operation and maintenance, The cost of down time from carbon black fines outweighs these costs in high volume production but smaller volume rubber mixing operations may not see a fast enough return on their investment.

Similar problems exist where screw conveyors, such as an auger screw, are used in applications involving cooling below ambient temperature.

### SUMMARY OF THE INVENTION

An object of this invention is to provide improvements for heating or cooling a screw conveyor, particularly a volumetric screw conveyor.

A further object of this invention is to provide such a heated/cooled screw conveyor which is particularly thermally efficient and which provides for a more uniform temperature throughout the heated/cooled zone.

A heated/cooled screw conveyor includes a thermosyphon in the hollow screw shaft of the conveyor. The thermosyphon is in the form of a hollow tube in contact with the inner surface of the shaft for transferring heat/cold by direct contact with the shaft.

In a preferred practice of the invention the thermosyphon tube is mounted against the inner surface of the shaft in such a manner that an integral unit results whereby the thermosyphon rotates with the rotation of the shaft. Preferably, the thermosyphon includes a wick mounted within the thermosyphon tube in such a manner that liquid may flow between the outer surface of the wick and the inner surface of the thermosyphon tube while vapor flows in the opposite direction through the tubular wick itself.

### THE DRAWINGS

FIG. 1 is a side elevational view partly in section of a heated screw conveyor in accordance with this invention;

FIG. 2 is a cross sectional view in elevation of the screw conveyor shown in FIG. 1; and

FIG. 3 is a cross sectional view in elevation of the thermosyphon used in the screw conveyor of FIGS. 1-2.

### DETAILED DESCRIPTION

The present invention addresses problems relating to the inefficiency and high operating costs of conventional heated screw conveyors. A key feature of the invention is the use of a thermosyphon to heat the screw instead of using a cartridge heater. The thermosyphon in the preferred practice of the invention is an integral part of the screw shaft rotating with the screw shaft and transferring heat by conduction through direct contact rather than radiation. The thermosyphon works on the principle of latent heat of evaporation. Since the latent heat of evaporation is large the thermosyphon has the capacity to transfer large amounts of heat at high speeds in both heating and cooling operations. Therefore a small heated section of thermosyphon will transfer the heat/cold along its entire length rapidly and efficiently. Theoretically the thermosyphon will be 2.5 times more efficient than conventional cartridge heater designs. The thermosyphon design will also heat/cold the screw uniformly from end to end because the thermosyphon will be an integral part of the screw.

Heat can be supplied to the thermosyphon from, for example, electric band heaters attached directly to an exposed end of the screw shaft as later described. These band heaters are commonly used items that are readily available from commercial supply houses. The same band heaters will work on any thermosyphon equipped conveyor regardless of length. The extremely larger cartridge heaters currently used are custom made and require several weeks for manufacturer. Their length is also custom fit to each individual conveyor. Thus, if one has twelve heated screw conveyors of customized length, there is a need to stock 12 spare heaters. Heaters are not interchangeable.

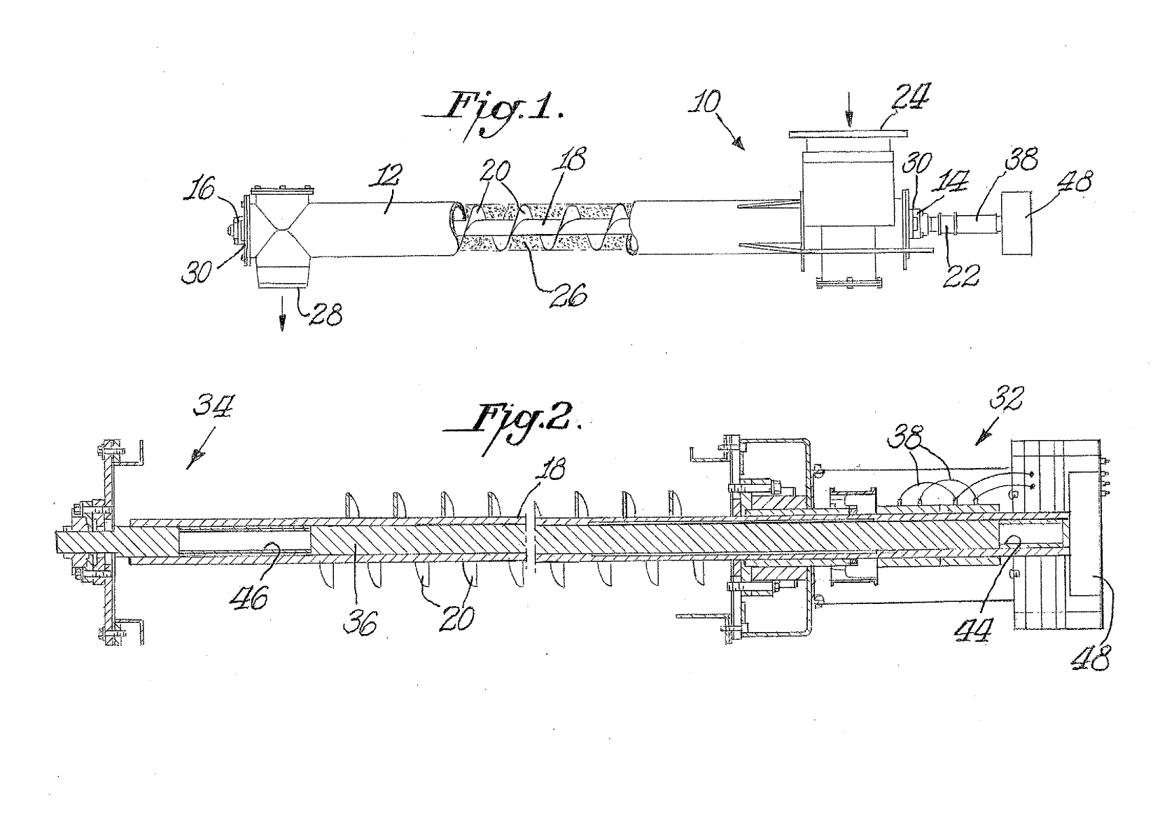

FIG. 1 illustrates a screw conveyor 10 which includes many components of typical screw conveyors but which can also include a thermosyphon in accordance with this invention. Screw conveyor 10 is illustrated as a volumetric screw conveyor. As shown in FIG. 1 the conveyor 10 has a tubular housing 12 with bearings 14,16 supporting the heated screw 18 from each end. The screw 18 is a hollow shaft which may be fabricated from carbon steel or stainless steel tubing with flights 20 welded to the outer surface or outside circumference of the screw shaft. The screw is driven to rotate by, for example, a timing belt engaged in sprocket 22 and another sprocket attached to a drive motor. Bulk material is fed to the inlet 24 and passes through the housing 12 by being carried along by the rotating action of the heated screw 18. The conveyed material 26 then discharges through opening 28. Seals 30 keep fine material from leaking out of the screw housing 12. Such screw conveyor is particularly adaptable for conveying such materials as carbon black. A known screw conveyor having these features is disclosed in U.S. Pat. No. 4,834,647, all of the details of which are incorporated herein by reference thereto.

Screw conveyor 10 would be used as a heated screw conveyor when treating, for example, rubber in a molding process and could be used as a cooling screw conveyor when treating, for example, plastic material in an injection process.

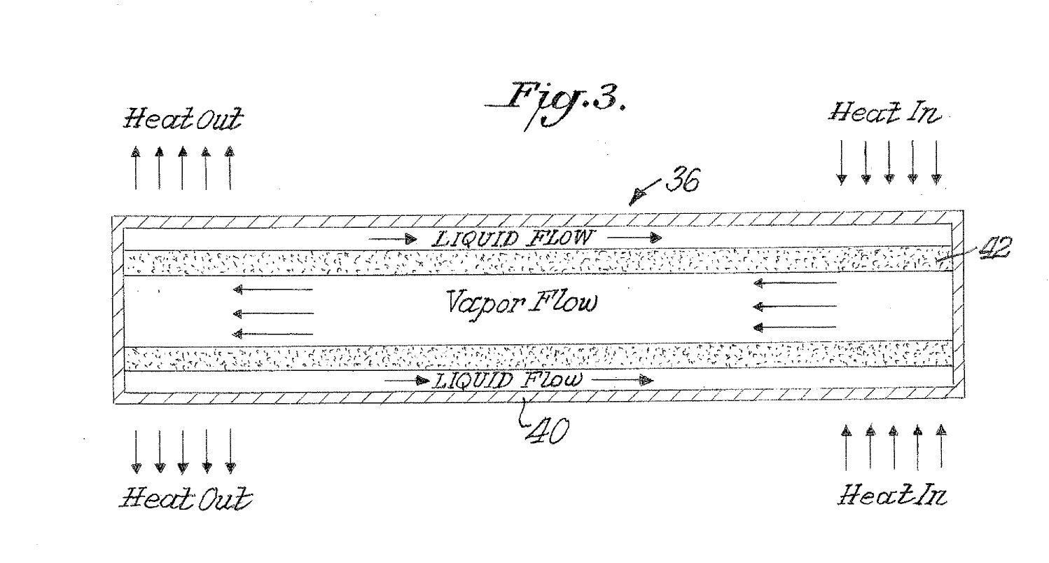

FIG. 2 illustrates in cross section details of a screw conveyor which would be a practice of this invention. In particular FIG. 2 illustrates the details at the drive end 32 and the discharge end 34. A key feature in the practice of this invention is the incorporation of a thermosyphon 36 within the hollow shaft of screw 18 as later described.

As shown in FIG. 2 the drive end 32 is provided with electric band heaters 38. Heat is transferred through the screw shaft 18 and picked up by the thermosyphon 36.

FIG. 3 illustrates in greater detail the thermosyphon 36. As shown in FIG. 3 the thermosyphon in its preferred construction is a hollow tube 40 closed at both ends. A tubular wick 42 is mounted in thermosyphon tube 40 and has a small outside diameter than the inside diameter of tube 40 so that there is an annular chamber formed between the wick 42 and the inner surface of tube 40. Wick 42 is made from any suitable permeable material, preferably a metal material.

As shown in FIG. 2 in the preferred practice of this invention thermosyphon 36 is of a length which extends from the drive end 32 through the length of shaft 18 to at least and preferably beyond the last flight 20. The precise location of thermosyphon 36 within hollow shaft 18 is controlled by locating suitable stop members 44,46 at the drive end 32 and discharge end 34 of the hollow shaft 18. The length of the stop members 44,46 will control the precise position of thermosyphon 36 within hollow shaft 18. Although the stops 44,46 are illustrated as tubular members, any other form of stop can be used within the broad practice of this invention.

Returning again to FIG. 3 as shown therein heat enters the drive end of the thermosyphon 36 which causes vapor to flow in a direction from the drive end to the discharge end within the hollow wick 42. Liquid flows in the opposite direction in the chamber between the wick 42 and the inner surface of thermosyphon tube 40. Heat exits the thermosyphon 36 at the discharge end. This form of thermosyphon is highly efficient and the temperature differential from end to end of the heated/cooled section of screw 18 would be in the range of ±1° C.

During manufacture the thermosyphon 36 is inserted into one end of the hollow screw shaft 18 until the thermosyphon abuts against one of the stop members. After being positioned within the hollow shaft 18 the other stop member is inserted to fix the location of thermosyphon 36. In a preferred practice of this invention the thermosyphon tube 40 is made of a heat conductive material and is preferably a copper housing while the screw shaft 18 is made of carbon steel or stainless steel. The coefficient of expansion is significantly higher for copper than for steel or stainless steel. This causes the thermosyphon outside diameter of tube 40 to increase more than the inside diameter of the inner surface of shaft 18 when both are heated. In this case, when the thermosyphon 36 is inserted into the hollow shaft 18 the assembly is heated to a temperature in excess of 288° C. The assembly will be held at such elevated temperature long enough for the thermosyphon copper housing 40 to yield and thus not return to its original diameter after the heat is removed. The result of this is a positive mechanical contact between the screw shaft 18 and the thermosyphon 36.

Since the screw shaft 18 and thermosyphon 36 form an integral unit by virtue of the expansion of thermosyphon 36 they will rotate together when the screw is in operation. The band heaters 38 are also attached to the screw 18 and will rotate in unison. To supply power to the band heaters 38 requires the use of a rotary contact 48. Rotary contact 48 has a set of stationary contacts that will connect to the power supply and a set of rotating contacts that will rotate in unison with the screw 18 and supply power to the band heaters 38.

An advantageous feature of the invention is that the heat source or cooling source would be located entirely at one end of the screw.

The present invention creates a significantly efficient heated screw assembly far superior to the conventional state of the art technology whether heated by electricity, steam or some other medium which does not come close to the thermal efficiency of the present invention. Such conventional systems create a thermal gradient along the length of the screw that requires significantly more heat energy input into the system than the recirculating closed loop system provided by thermosyphon 36. The Wattage input required for the present invention is much smaller because the heat transfer system is approximately 2.5 times more efficient. The band heaters 38 that can be used are less expensive and can be stocked for a variety of screw conveyors. The heat input can also be supplied by a variety of other sources, not simply electrical, but also including but not limited to steam, hot water, hot air and hot oil.

The present invention also allows for extracting heat from the material as it is being conveyed with the same thermal efficiency as described for heating. This opens the possibility of utilizing the invention for applications for cooling a product while conveying it as well as for heating. Thus, for example, the present invention could be used for cooling a rotating auger screw internally by various cooling mediums including, but not limited to, chilled water, chilled gases and cryogenic liquids. Thus, in a broad sense the invention utilizes thermal applicating structure which could be either for heating or for cooling a rotating screw. Use of the invention would result in a thermal efficiency greater than 95% and in providing a more uniform temperature throughout the heated or cooling zone which would be ±1° C.

What is claimed is:

1. In a screw conveyor having a hollow screw shaft with an outer surface and an inner surface, a flight mounted to and extending outwardly from said outer surface over at least a portion of the length of said shaft, rotating structure mounted to said shaft for rotating said shaft, and thermal applicating structure for adjusting the temperature of said screw conveyor to a non-ambient temperature, the improvement being in that a thermosyphon is mounted in said shaft, and said thermosyphon including a hollow tube in contact with said inner surface of said shaft for transferring heat/cold by direct contact with said shaft.

2. The screw conveyor of claim 1 wherein said thermosyphon tube is made of a heat conductive material.

3. The screw conveyor of claim 1 wherein said thermosyphon tube is mounted in direct surface to surface contact with said shaft to rotate along with said shaft.

4. The screw conveyor of claim 3 wherein said thermosyphon tube is made from a material having a higher coefficient of expansion than the material of said shaft to cause the outside diameter of said thermosyphon tube to increase more than the inside diameter of said shaft when said thermosyphon tube and said shaft are heated whereby said thermosyphon tube does not return to its original diameter after the heat is removed to create a positive mechanical contact between said shaft and said thermosyphon tube.

5. The screw conveyor of claim 3 including a tubular wick mounted in said thermosyphon tube, and said tubular wick having an outside diameter smaller than the inside diameter of said thermosyphon tube to create a space between the outer surface of said wick and the inner surface of said thermosyphon tube.

6. The screw conveyor of claim 5 wherein said wick is in the form of a hollow metal tube whereby liquid may flow in the spacing between said wick and said thermosyphon tube in an upstream direction and vapor may flow within said wick in a downstream direction with heat being applied into said thermosyphon at its upstream end and being discharged from said thermosyphon in its downstream end.

7. The screw conveyor of claim 6 wherein both ends of said thermosyphon tube are closed, and said thermosyphon tube being made from copper.

8. The screw conveyor of claim 6 wherein said thermosyphon has a length extending from the drive end of said screw to at least the end of said flight at said discharge end.

9. The screw conveyor of claim 8 including a stop member mounted within said shaft at each end of said shaft and abutting against a respective end of said thermosyphon to control the location of said thermosyphon within said shaft.

10. The screw conveyor of claim 9 wherein said thermosyphon extends slightly beyond the end of said flight.

11. The screw conveyor of claim 10 wherein said thermal applicating structure is located entirely at one end of said screw shaft.

12. The screw conveyor of claim 11 wherein said thermal applicating structure is a heat source.

13. The screw conveyor of claim 12 wherein said heat source is selected from the group consisting of electrical, steam, hot water, hot air, and hot oil.

14. The screw conveyor of claim 12 wherein said heat source comprises band heaters mounted directly to said shaft for rotating with said shaft.

15. The screw conveyor of claim 11 wherein said thermal applicating structure is a cooling medium.

16. The screw conveyor of claim 15 wherein said cooling medium is selected from the group consisting of chilled water, chilled gases and cryogenic liquids.

17. The screw conveyor of claim 1 including a tubular wick mounted in said thermosyphon tube, and said tubular wick having an outside diameter smaller than the inside diameter of said thermosyphon tube to create a space between the outer surface of said wick and the inner surface of said thermosyphon tube.

18. The screw conveyor of claim 1 wherein said thermosyphon has a length extending from the drive end of said screw to at least the end of said flight at said discharge end.

19. The screw conveyor of claim 1 wherein said thermal applicating structure is located entirely at one end of said screw shaft.

20. The screw conveyor of claim 1 wherein said thermal applicating structure is a heat source.

21. The screw conveyor of claim 20 wherein said heat source is selected from the group consisting of electrical, steam, hot water, hot air, and hot oil.

22. The screw conveyor of claim 1 wherein said thermal applicating structure is a cooling medium.

23. The screw conveyor of claim 22 wherein said cooling medium is selected from the group consisting of chilled water, chilled gases and cryogenic liquids.
